(19) United States
(12) Patent Application Publication
(10) Pub. No.: US 2004/0100877 A1
(43) Pub. Date: May 27, 2004

(54) Entertainment apparatus

(76) Inventor: Jen-Fu Chen, Feng Yuan City (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 10/360,174

(22) Filed: Feb. 7, 2003

(30) Foreign Application Priority Data
Nov. 22, 2002 (TW) 91134254

(51) Int. Cl. G11B 7/085; G11B 21/08

(52) U.S. Cl. 369/30.63

(57) ABSTRACT

An entertainment apparatus includes a frame, a compact disc player, a compact disc storage device and a compact disc feed. The compact disc player is mounted on the frame. The compact disc storage device is rotationally mounted on the frame and defines a plurality of slits each for receiving a compact disc. The compact disc feed can feed a selected one of the compact discs to the compact disc player from the compact disc storage device.

### BACKGROUND OF INVENTION

1. Field of Invention

The present invention relates to an entertainment apparatus and, more particularly, to a entertainment apparatus capable of supporting a plurality of compact discs and selectively playing one of the compact discs.

2. Related Prior Art

Taiwanese Patent Publication No. 125824 discloses a personal video and audio player. This personal video and audio player includes a frame 12, a miniature television 1 mounted on the frame 12, a radio (not numbered) mounted on the frame 12, a compact disc player 3 detachably mounted on the frame 12 and two speakers 5 pivotally mounted on the frame 12. This video and audio player is however unable to support more than one compact disc.

Taiwanese Patent Publication No. 428775 discloses a compact disc player capable of supporting a few compact discs and selectively playing one of the compact discs. This compact disc player includes a chassis 3, a swivel 5 for supporting several compact discs, a reader 4 for selectively reading one of the compact discs and a transmission 7 for rotating the swivel 5 on the chassis 3 so that one of the compact discs can be read by means of the reader 4. This compact disc player is however unable to support a lot of compact discs without occupying a huge area since they compact discs are supported in a common plane.

The present invention is therefore intended to obviate or at least alleviate the problems encountered in prior art.

### SUMMARY OF INVENTION

It is the primary objective of the present invention to provide an entertainment apparatus capable of supporting a lot of compact discs and selectively playing one of the compact discs.

According to the present invention, an entertainment apparatus includes a frame, a compact disc player, a compact disc storage device and a compact disc feed. The compact disc player is mounted on the frame. The compact disc storage device is rotationally mounted on the frame and defines a plurality of slits each for receiving a compact disc. The compact disc feed can feed a selected one of the compact discs to the compact disc player from the compact disc storage device.

Other objects, advantages, and novel features of the invention will become more apparent from the following detailed description when taken in conjunction with the attached drawings.

### BRIEF DESCRIPTION OF DRAWINGS

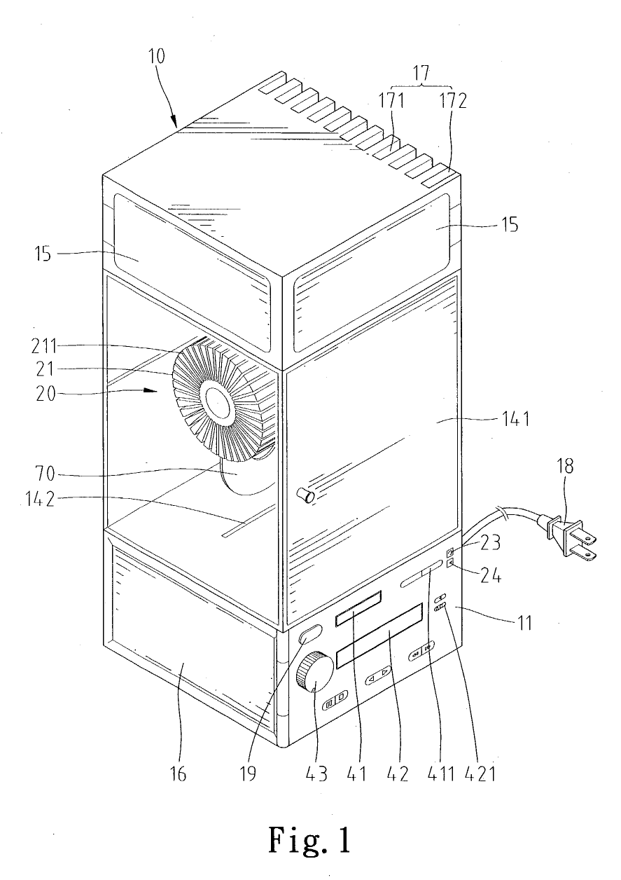

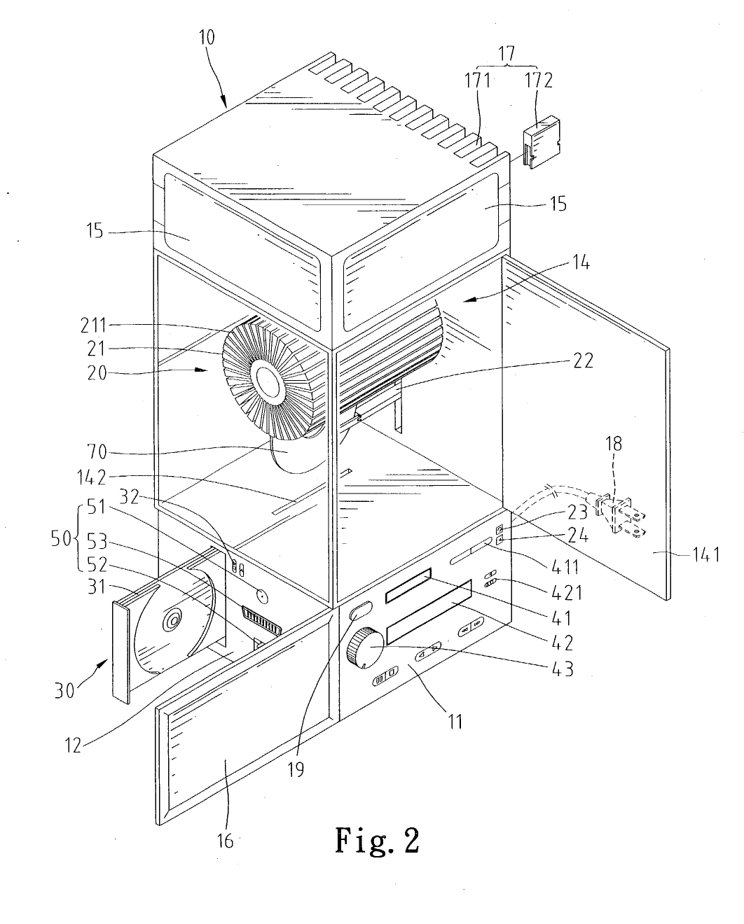

The present invention will be described through detailed illustration of embodiments referring to the attached drawings wherein: FIGS. 1˜6 are perspective views of an entertainment apparatus in various positions according to the preferred embodiment of the present invention.

### DETAILED DESCRIPTION OF PREFERRED EMBODIMENT

Referring to FIGS. 1˜6, according to the preferred embodiment of the present invention, an entertainment apparatus includes a frame 10 including an upper portion, a middle portion and a lower portion.

Two speakers 15 are pivotally mounted on the upper portion of the frame 10. A memory device 17 is mounted on the upper portion of the frame 10. The memory device 17 includes a plurality of ports 171 for engagement with a corresponding number of memory cards 172. Data such as audio and video data can be stored in these memory cards 172.

A board (not numbered) is located between the middle and lower portions of the frame 10. The middle portion of the frame 10 defines a space 14. The lower portion of the frame 10 defines a space (not numbered). The board defines a slot 142 through which the space 14 is communicated with the space defined in the lower portion of the frame 10. The space 14 is exposed through an opening 11 that can be closed by means of a door 141 pivotally mounted on the frame 10. A compact disc storage device 20 is installed in the space 14. The compact disc storage device 20 is in the form of a wheel rotationally mounted on an axle (not shown) installed at the middle portion of the frame. 10. The compact disc storage device 20 includes a plurality of leaves 21 any adjacent two of which are separated from each other by means of a slit 211. Each of the slits 211 can receive a compact disc 70 retained therein via two of the leaves 21. A compact disc feed 22 is installed at the middle portion of the frame 10.

The entertainment apparatus can be plugged via a plug 18 formed on a cable (not numbered) leading from the lower portion of the frame 10. On the lower portion of the frame 10 is mounted a first panel 11 and a second panel 12. The entertainment apparatus is turned on and off via a switch 19 mounted on the first panel. On the first panel 11 is mounted a knob 23 for controlling the rotation of the compact disc storage device 20. Also on the first panel 11 is mounted a switch 24 for controlling the operation of the compact disc feed 22.

A compact disc player 30 is installed at the lower portion of the frame 10. The compact disc player 30 includes a tray 31 that can be concealed in and moved from the lower portion of the frame 10 through a slot (not numbered) defined in the second panel 12. On the second panel 12 is mounted a switch 32 for controlling the operation of the compact disc player 30. The other components of the compact disc player 30 are not shown or described.

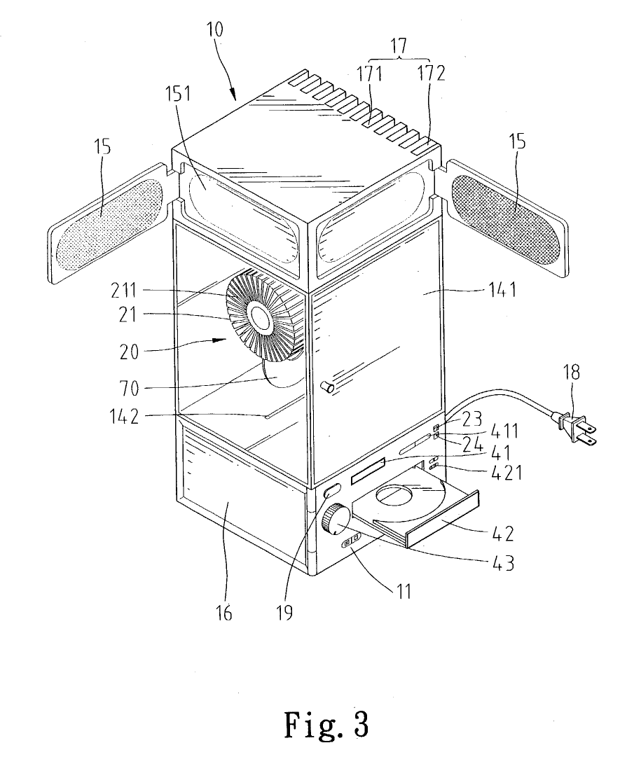

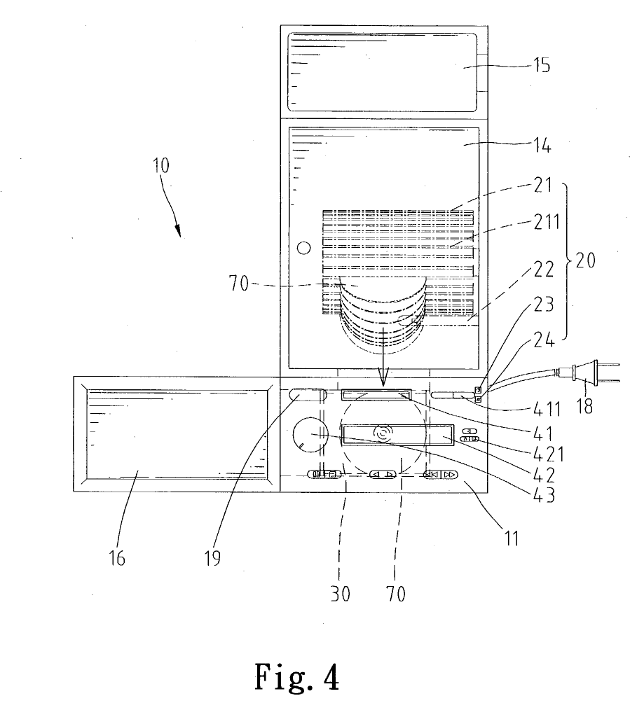

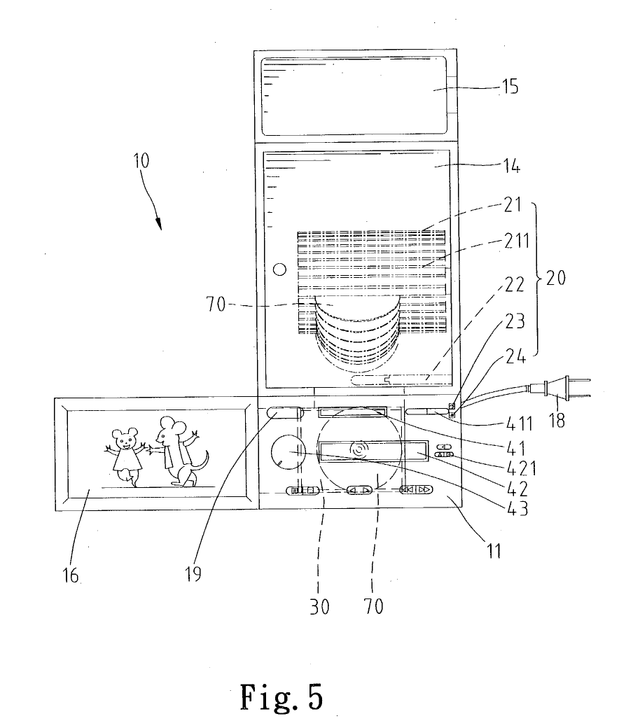

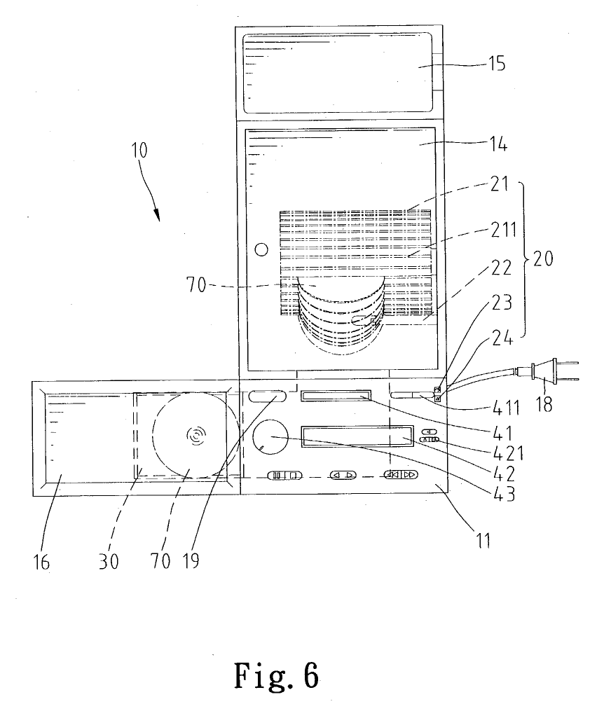

Referring to FIG. 4, the compact disc feed 22 can take a compact disc from the compact disc storage device 20. Referring to FIG. 5, the compact disc feed 22 can toss the compact disc 70 from the middle portion of the frame 10 into the lower portion of the frame 10 through the slot 142. Referring to FIG. 6, the tray 31 can be moved from the lower portion of the frame 10 so that the compact disc 70 can be removed from the tray 31.

A display 16 is pivotally installed at the lower portion of the frame 10. The second panel 12 can be concealed by means of the display 16.

A radio 41 is installed at the lower section of the frame 10. On the first panel 11 are mounted two buttons 40 for controlling the tuning of the radio 41. A compact disc recorder 42 is installed at the lower section of the frame 10. On the first panel 11 is mounted a switch 421 for controlling the operation of the compact disc recorder 42.

An input/output assembly 50 is installed at the lower portion of the frame 10. The input/output assembly 50 includes a first port 51 for connection with a television cable (not shown), a second port 52 for connection with a network cable (not shown) and a third port 53 for connection with a printer cable (not shown).

The present invention has been described through detailed illustration of the preferred embodiment. Those skilled in the art can derive variations from the preferred embodiment without departing from the scope of the present invention. Therefore, the preferred embodiment shall not limit the scope of the present invention defined in the claims.

What is claimed is

1. An entertainment apparatus including:
a frame;
a compact disc player mounted on the frame;
a compact disc storage device rotationally mounted on the frame, the compact disc storage device defining a plurality of slits each for receiving a compact disc; and
a compact disc feed for feeding a selected one of the compact discs to the compact disc player from the compact disc storage device.

2. The entertainment apparatus according to claim 1 wherein the compact disc storage device is in the form of a wheel.

3. The entertainment apparatus according to claim 1 including a panel mounted on the frame.

4. The entertainment apparatus according to claim 3 wherein the compact disc player includes a tray that can be moved into and moved from the frame 10 through a slot defined in the panel.

5. The entertainment apparatus according to claim 4 including a display pivotally mounted on the frame between a first position for concealing the panel and a second position for exposing the panel.

6. The entertainment apparatus according to claim 1 including two speakers pivotally mounted on the frame.

7. The entertainment apparatus according to claim 1 including a memory device mounted on the upper portion of the frame.

8. The entertainment apparatus according to claim 7 wherein the memory device includes a plurality of ports for engagement with a corresponding number of memory cards.

9. The entertainment apparatus according to claim 1 including a display pivotally mounted on the frame.

10. The entertainment apparatus according to claim 1 including a panel mounted on the frame.

11. The entertainment apparatus according to claim 1 including a radio mounted on the frame.

12. The entertainment apparatus according to claim 1 including a compact disc recorder mounted on the frame.

13. The entertainment apparatus according to claim 1 including an input/output assembly mounted on the frame.

14. The entertainment apparatus according to claim 13 wherein the input/output assembly includes a port for connection with a television cable.

15. The entertainment apparatus according to claim 13 wherein the input/output assembly includes a port for connection with a network cable.

16. The entertainment apparatus according to claim 13 wherein the input/output assembly includes a port for connection with a printer cable.
